(19) United States
(12) Patent Application Publication
(10) Pub. No.: US 2002/0134738 A1
(43) Pub. Date: Sep. 26, 2002

(54) Process and device for melting thermoplastic material

(76) Inventors: Gennady Volokitin, Tomsk (RU); Viktor Gapeev, Gifhorn (DE); Serguey Zotov, Tomsk (RU)

Correspondence Address: Whitham, Curtis & Christofferson PC, Suite 340, 11491 Sunset Hills Road, Reston, VA, 20190, US

(21) Appl. No.: 09/988,052

(22) Filed: Nov. 16, 2001

(30) Foreign Application Priority Data
Mar. 12, 2001 (DE) 10112090.7

(51) Int. Cl. B29B 15/00; B29B 17/00; B01D 21/26

(52) U.S. Cl. 210/773; 264/349; 264/913; 210/774; 210/781; 210/787; 210/178; 210/360.1; 210/512.1

(57) ABSTRACT

In melting thermoplastic material, particularly in the form of strip-like or fibrous refuse, where the material is melted through contact with a liquid heat-transfer medium and is then separated from the heat-transfer medium, and to assure a high degree of effectiveness and to maintain a high level of quality in the molten material, it is provided that steam at a temperature distinctly higher than the melting temperature of the material is used as a heat-transfer medium and is conducted over the introduced material, the molten or at least semi-molten material is entrained by the flowing steam and is then separated from the steam at a temperature lying above the melting temperature of the material, and the steam is returned to the circuit.

### BACKGROUND OF THE INVENTION

1. Field of the Invention

The invention relates to a process for melting thermoplastic material, specifically in the form of strip-like or fibrous refuse, the material is melted through contact with a liquid heat-transfer medium and is lien separated from the heat-transfer medium. The invention also relates to a device for implementing the process.

2. Background Description

The prior art is acquainted with the utilization of thermoplastic polymer refuse which has a low powder density, for example, strip like or fibrous cuttings produced in businesses which manufacture synthetic fibers and plastic materials, and specifically with the utilization of the refuse through melting and reprocessing.

In principle it is known to melt the thermoplastics in special devices in which a compartment, e.g., one with a liquid heat-transfer medium, is heated, and the heat-transfer medium does not come into contact with the thermoplastic material. The compartment can therefore take the form of an extruder, while the heat-transfer medium is guided through the compartment walls and through a hollow worm-gear in order to heat these parts of the extruder. Devices of this kind require relatively large amounts of energy, since the entire melting compartment must be heated and the thermoplastic material is indirectly heated. The resulting heat losses make for a low degree of effectiveness.

It has been attempted, consequently, to melt the thermoplastic material in direct contact with a liquid heat-transfer medium. For example, it is known to introduce the thermoplastic material, in the form of solid particles, into a melting furnace partially filled with liquid metal. The solid particles are melted in the course of transport, and the melt separates on the metal surface as the result of the lower specific gravity. Implementing this process meets with numerous difficulties. To avoid destroying the thermoplastic material a metal with a low melting temperature must be employed. Metals of this kind are generally aggressive, however. Furthermore, a fine dispersive comminution of the polymer is necessary. It is also difficult to obtain an ecologically acceptable separation of the melt from the metal.

Attempts have been made to melt organic products with the aid of microwaves. Here the material must be placed in a microwave oven in which the microwaves are directed at the surface of the material. This results in a liquid-particle mixture, in which the particles must be further melted. After the complete melting of the material the oven is emptied and refilled. The use of magnetic microwave radiation requires special safety measures, which make the process and the accompanying equipment complicated and expensive. In the case of higher melting points, as required, e.g., in melting polyethylene, high microwave energy inputs are also required.

In another process the thermoplastic polymer material is melted with the aid of an inert liquid heat medium. The liquid employed mist be considerably more viscous for the melting temperature than the polymermelt. By means of a mechanical pressure, which causes the mixture components to move at differing speeds—a movement dependent on the viscosity—the more viscous component (the heat medium) is removed from the mixture. Since high pressures are sometimes needed for this kind of separation of the mixture a not inconsiderable energy is required for building up a sufficient mechanical pressure. This results in a reduction in the degree of efficacy.

### SUMMARY OF THE INVENTION

It is therefore an objective of the present invention is to provide a solution to the problem of permitting the thermoplastic material to be melted with a high degree of efficacy while avoiding the destruction of the thermoplastic material, particularly by local overheating.

According to the present invention, the foregoing and other objectives are achieved in part by a process for melting thermoplastic material, particularly in the form of strip-like or fibrous refuse. The thermoplastic material is melted through contact with a liquid heat-transfer medium and is then separated from the heat-transfer medium. Steam at a temperature distinctly higher than the melting temperature of the material is used as a heat-transfer medium and is conducted over the introduced material. The molten or at least semi-molten material is entrained by the flowing steam and is then separated from the steam at temperature lying above the melting temperature of the material, and the steam is returned to the circuit.

Additional objectives, aspects and advantages of the present invention will become readily apparent to those skilled in this art from the following detailed description. As will be realized, the present invention is capable of other and different embodiments and its several details are capable of modifications in various obvious respects, all without departing from the present invention. Accordingly, the drawings and description are to be regarded as illustrative in nature, and not restrictive.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a system for melting thermoplastic material in accordance with an embodiment of the present invention.

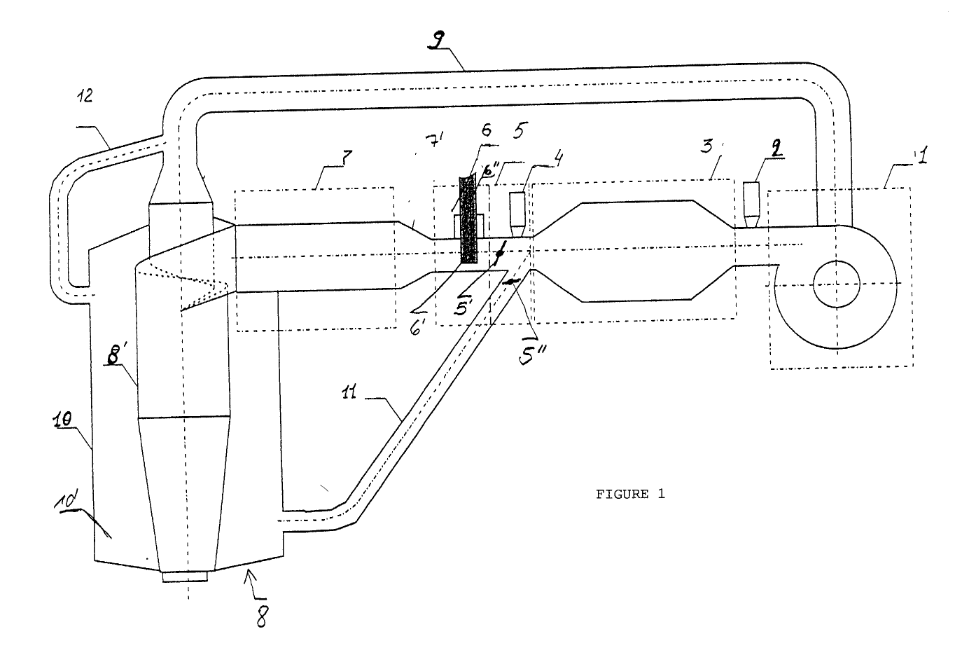

### DETAILED DESCRIPTION OF A PREFERRED EMBODIMENT OF THE INVENTION

The process according to the invention is based on the continuous recirculation of steam as the heat-transfer medium, particularly water vapor, and on the fact that melting and the separation of the molten material from the heat-transfer medium are performed during the continuous circulation of the steam. The material is fed to the steam circuit in such a way that the steam flows around it and the material is consequently melted or semi-melted and is also drawn along by the steam. In the steam flow, only semi-molten material particles can at first continue to melt. The separation of the molten material from the steam flow then follows, and the temperature that lies above the melting temperature is maintained during separation process, so that particles can be completely melted even during the separation process. Separation of the molten material from the steam can be performed with known methods for separating a liquid or solid material from a gaseous material, for example, by a filter material that is permeable to gases but impermeable, to liquids. Preferred in the context of the invention, however, is the separation of the molten material from the steam by means of centrifugal force, i.e.. by means of a centrifugal separator.

The process according to the invention can be implemented with a high degree of efficacy, i.e., a low energy input, and requires no additional energy for the transport of the molten material. With the melting and separation processes within the continuous flow of steam, the expense in terms of batch-like feed and removal of the material is avoided Furthermore, the use of steam causes local condensation events to occur on the not yet molten particles of thermoplastic material, events which protect the material from local overheating as the result of a protective steam layer that arises through condensation of the liquid and the ensuing, renewed vaporization. This feature represents the basic advantage of steam usage as specified by the invention, particularly the use of water vapor.

It is particularly advantageous in the invention process if the steam is heated to a defined temperature before introduction of the material and a part of the heated steam is diverted after heating in order to adjust the temperature for the separation of steam and material. The temperature for the separation of the material and the steam is also set by the water vapor, which is diverted in front of the melting zone for the material.

In the melting zone the material will ideally be moved into the streaming vapor, within a container through which the vapor can flow. The container can continue outward, i.e., outside the steam line and can there be continuously fed with more material for melting.

For the technical process, it is highly advantageous if the flow rate of the mixture of steam and entrained material beyond the melting zone is distinctly reduced. Here a reduction by a factor greater then 10 is advantageous; ideally the reduction will be by a factor of 20. The high flow rate required for the energy input into the material being melted and the entrainment of the molten or semi-molten material is not needed for the further transport and continued energy exchange between the steam and the material. Thus, with the reduction of the flow rate the line length required for the necessary contact period can be reduced and, furthermore, the flow rate that is workable in the separating device can be accommodated.

For conventional thermoplastic materials it is advantageous if the temperature of the steam entering the melting zone is set in a range from 300 to 500° C., ideally 400 to 500° C. The flow rate of this steam will best lie between 80 and 100 m/s and ideally between 90 and 100 m/s. The density of the steam for contact with the material being melted will ideally be adjusted to 1.15 to 1.25 kg/m³ in order to achieve a sufficient protective effect of the type described above for the material particles.

A device suitable for implementing the process according to the invention exhibits a fan for the continuous circulation of steam in a conducting circuit; at least one nozzle for the controlled introduction of liquid into the steam current; a steam heater and attached to it a melting compartment in which the material projects into the flow of steam; and a heated separator stage for separating the steam from the molten material.

To heat the separator stage a branch line upstream From the melting compartment will ideally branch off and open into a housing for the separator stage. The separator stage here can exhibit a closed separator compartment, which, with the housing, forms a heating space through which the steam passes and from which an outlet line opens into the conducting circuit for the steam.

To reduce the flow rate of the steam/material mixture downstream from the melting compartment it is expedient to insert between the melting compartment and the separator stage a conducting component with a flow cross-section that is distinctly enlarged as compared to the melting compartment. The invention will next be explained in greater detail on the basis of an exemplary embodiment shown in the drawing.

The single figure shows a fan 1 that serves to circulate the water vapor in a closed conducting circuit for the water vapor. The far produces the necessary speed in the steam current. Attached to the fan is a nozzle device 2, which by spraying water will establish the needed steam density in front of a steam heater 3. The steam heater 3 is a cylinder-shaped compartment, with a braking mechanism for the steam flow in the form of a cross-sectional enlargement and with a steam accelerator in the form a cross-sectional reduction.

In the steam heater 3 the steam is heated to temperatures from 300 to 500° C. There follows another nozzle device 4 in which Later is sprayed into a cavity for the flow, specifically in order to regulate the pressure. The steam thus conditioned reaches a steam flow distributor 5, from Which a branch line 11 diverges. With the flow valves 5′, 5″ the volumetric flows can be adjusted for the branch line and the main line. In the main line the steam flow distributor is followed by a melting compartment 6, which is designed as a throughput melting compartment for the uninterrupted melting of the thermoplastic material. The melting compartment 6 is thus located within the steam line. Projecting into the melting compartment 6 is a lower part 6′ of a housing for the reception of the material being melted. An upper part 6″ of the housing projects out of the line and can be continuously fed outside of the conducting circuit with new material for melting.

Adjoining the melting compartment 6 by way of a cross-sectional enlargement 7′ is a melt line 7, whose other end is connected to the inlet of a separator stage 8. The separator stage 8 exhibits an inner sealed separator compartment 8′, which is enclosed by a housing 10. Between the housing 10 and the separator compartment 8′ is a heating space 10′ through which steam can pass; the lower end of this heating space 10′ is connected to the branch line 11 and its upper end is connected to a removal line 12. Guidance of the flow within the separator compartment 8′ causes a centrifugal acceleration of some magnitude in the steam/material mixture, with the result at the molten material runs downwards along the walls of the separator compartment 8′, while the steam passes through an outlet line 8″ into a collecting return line 9, in which the steam, together with the steam from the removal line 12, is aspirated by the fan 1, thereby closing the conducting circuit.

By means of the nozzle devices 2, 4 and the steam heater 3 the melting compartment 6 is fed with water vapor with a density from 1.12 to 1.15 kg/m³ , with a speed of ideally 90 to 100 m/s and a temperature of 300 to 500° C. The heated steam is blown at a high speed onto the polymer pieces in the lower housing part 6′ and brings them to the melting point. At the same time, it removes molten droplets from the material and draws them along. This also makes possible the removal of unmelted parts.

The steam current enters the melt line 7 together with the molten and unmolten pieces of material. Due the cross-sectional enlargement 7′ the speed of the steam current with the molten mass drops to 4 to 5 m/s. The mixture is guided through the centrifugal separator 8 preheated by the hollow space 10′, where it is separated into the polymermelt itself and the water vapor. Here the pieces that are not fully melted, which are located in the steam flow and then in the preheated centrifugal separator 8, are gradually melted. The polymermelt is thrown by the centrifugal forces against the walls of the outlet 8′ and flows down the walls. The steam separated from the melt is aspirated by the fan 1 along the collecting line 9.

Compiled in the following table are the optimal da,a on the implementation of the invention process with respect to the productivity of the melt formation as a function of the steam temperature and the steam speed. The date indicated in the table apply particularly to the melting of polyethylene.

| Steam | Steam | Melt | |
|---|---|---|---|
| Temperature | Speed | Productivity | |
| (T ° C.) | (V m/s) | (Q kg/h) | Remarks |
| 1 | 2 | 3 | 4 |
| 100 | 60 | 8 | Incomplete melting of initial |
| | 80 | 8.2 | raw material |
| | 100 | 9.4 | |
| | 120 | 9.3 | |
| 200 | 60 | 21 | Melt outflow with low |
| | 80 | 24 | plasticity |
| | 100 | 25.5 | |
| | 120 | 25 | |
| 300 | 60 | 43.8 | Good outflow of melt |
| | 80 | 57.4 | |
| | 100 | 60.5 | |
| | 120 | 58.4 | |
| 400 | 60 | 58.1 | High outflow of melt |
| | 80 | 64.1 | |
| | 100 | 73.3 | |
| | 120 | 67.2 | |
| 500 | 60 | 60.1 | Occurrence of disruptive |
| | 80 | 65.2 | elements in the melt |
| | 100 | 74.0 | |
| | 120 | 66.7 | |
| 550 | 60 | 44.7 | Sharp increase of disruptive |
| | 80 | 56.8 | elements; reduced melt |
| | 100 | 60.9 | outflow |
| | 120 | 57.1 | |

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A process for melting thermoplastic material, particularly in the form of strip-like or fibrous refuse, in which the material is melted through contact with a liquid heat-transfer medium and is then separated from the heat-transfer medium, wherein steam at a temperature distinctly higher than the melting temperature of the material is used as a heat-transfer medium and is conducted over the introduced material, the molten or at least semi-molten material is entrained by the flowing steam and is then separated from the steam at temperature lying above the melting temperature of the material, and the steam is returned to the circuit.

2. A process according to claim 1, wherein the steam is heated to a defined temperature before the material is introduced and, after heating, a portion of the heated steam is diverted in order to set the temperature for the separation of steam and material.

3. A process according to claim 1, wherein the material inside a container through which steam can flow is brought into the flowing steam.

4. A process according to claim 1, wherein the flow rate of the mixture of steam and entrained material is distinctly reduced.

5. A process according to claim 4, wherein the flow rate is reduced by more than factor of 10.

6. A process according to claim 5, wherein the flow rate is reduced by a factor of 20.

7. A process according to claim 1, wherein the steam and material are separated by means of centrifugal force.

8. A process according to claim 2, wherein the steam released by the entrained material, together with the steam used to adjust the temperature for the separation process, is guided to a steam accelerator.

9. A process according to claim 1, wherein the temperature of the steam is set at 300° C. to 500° C., ideally 400° C. to 500° C.

10. A process according to claim 1, wherein the flow rate of the steam is set at 80 to 120 m/s, ideally 90 to 120 m/s.

11. A process according to claim 1, wherein the density of the steam for contact with the material is set at 1.15 to 1.25 kg/m³ .

12. A process according to claim 1, wherein the steam employed is water vapor.

13. A device for implementing the process according to claim 1, with a fan for the continuous circulation of steam in a conducting circuit at least one nozzle device for the regulated introduction of liquid into the steam flow, a steam generator, behind which is positioned a melting compartment in which the material projects into the steam flow, and a heated separation stage for separating the steam from the molten material.

14. A device according to claim 13 with a branch line which diverges upstream from the melting compartment, which opens into a housing for the separator stage.

15. A device according to claim 14, in which the separator level exhibits a closed separator compartment, which together with the housing forms a heating space through which steam flows, from which heating space an outlet line opens into the steam circuit.

16. A device according to claim 13, in which the separator stage is a centrifugal separator.

17. A device according to claim 13, in which a conducting component with a clearly increased flow cross-section relative to the melting compartment is inserted between the melting compartment and the separator stage.

18. A device according to claim 13, in which the conducting circuit is closed.

19. A device according to claim 13, with a nozzle device for the regulated introduction of liquid for adjusting the steam density of the flowing steam, which nozzle device is positioned immediately in front of the melting compartment.

20. A device according to claim 13, in which a water reservoir is attached to at least one nozzle device.
